(19) United States
(12) Patent Application Publication
(10) Pub. No.: US 2009/0099766 A1
(43) Pub. Date: Apr. 16, 2009

(54) Map data update system

(75) Inventor: Shuuji Nakamura, Chita-gun (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/285,471

(22) Filed: Oct. 7, 2008

(30) Foreign Application Priority Data
Oct. 11, 2007 (JP) 2007-265765

(51) Int. Cl. G01C 21/20

(52) U.S. Cl. 701/200

(57) ABSTRACT

A cellular phone receives map update data from a digital broadcast provider before a start-up of a car navigation apparatus, stores the received map update data in a storage section, and transmits the map update data stored in the storage section to the car navigation apparatus in response to the start-up of the car navigation apparatus. Upon receiving the map update data, the car navigation apparatus updates map data.

### CROSS REFERENCE TO RELATED APPLICATION

This application is based on and incorporates herein by reference Japanese Patent Application No. 2007-265765 filed on Oct. 11, 2007.

### FIELD OF THE INVENTION

The present invention relates to a map data update system.

### BACKGROUND OF THE INVENTION

A conventional map data update is performed by connecting a car navigation apparatus and a portable phone with each other to thereby always download map update data from a distribution center to anywhere via the phone network. This can eliminate a need for a user to visit a specific place such as a car dealer. Patent document 1 describes a technology using a mobile communication infrastructure of a cellular phone or the like, which always broadcasts map data specific to each cell. The cellular phone always receives the data and continues to revise the map data to that specific to the corresponding cell or area to thereby prevent storing the wide range of the map data.

A car navigation apparatus stores map data having a large data volume from several G bytes to several tens of G bytes. In contrast, a portable phone has a data transmission speed of about 384 k bps and adopts a weight system in data fee collection. Thus, like the technology in Patent document 1, only the very limited small data volume may be treated or downloaded by the portable phone. This decreases the user's convenience.

The method of distributing large data-volume map update data can use a cheaper and faster communication method such as a wireless LAN communication (IEEE802.11g: 54 Mbps) or a broadcast on-demand communication (for example, Media FLO of 6 MHz bands/300 bps/ch×N: 6 Mbps at maximum). The wireless LAN can be only used in limited areas where wireless LAN spots are arranged. Thus, a user may need to search for an area of the wireless LAN spot. This may disturb the user's convenience.

Patent document 1: JP-2001-34889 A

### SUMMARY OF THE INVENTION

It is an object to provide a map data update system, which need not choose a place for receiving map data having a large data volume and helps avoid giving stress to a user at the time of the update of the map data.

As an example of the present invention, a map data update system is provided as follows. A map update data broadcast installation is included to have a broadcast apparatus for broadcasting map update data over data broadcast waves. A mobile communication apparatus is included to have (i) a data broadcast receiver for receiving the map update data broadcast from the map update data broadcast installation, (ii) a storage device for storing the map update data received by the data broadcast receiver, and (iii) a short-distance transmitter for transmitting the map update data stored in the storage device via short distance communication. A vehicular navigation apparatus is included to have map data and a short-distance receiver for receiving the map update data transmitted by the mobile communication apparatus. Herein, the mobile communication apparatus receives the map update data before a start-up of the navigation apparatus, stores the received map update data in the storage device, and transmits to the navigation apparatus the map update data stored in the storage device in response to the start-up of the navigation apparatus. Upon receiving the map update data, the navigation apparatus updates the map data.

Herein, the mobile communication apparatus may include a cellular phone or PDA (Personal Digital Assistants) and may be defined as being usable in data reception with little restriction with respect to a communication area and a time zone. Further, the mobile communication apparatus is also designed as including a large data-volume storage device capable of receiving data broadcast waves. Thus, regardless of states of use of the vehicle by a user, the map update data distributed as data broadcast waves can be received by the mobile communications apparatus before the start-up of the car navigation apparatus.

The map update data is previously stored in the mobile communication apparatus when the user gets in the vehicle. At the time of the start-up or in response to the start-up of the car navigation apparatus, the map update data can be fast transmitted from the mobile communication apparatus to the car navigation apparatus via a short distance communication such as Bluetooth (registered trademark) and wireless LAN (Local Area Network). This results in no need of choosing a place for receiving the large data-volume map data. In addition, this can avoid as much as possible giving stress to the user at the time of the update of the map data.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of a map data update system according to an embodiment of the present invention;

FIG. 2 is a flowchart of a process for the map data update system;

FIG. 3 is a flowchart of an acquisition process for map update request information;

FIG. 4 is a flowchart of a registration process for map update request information and a report process for a broadcast program of map update data;

FIG. 5 is a flowchart of a reception reservation process for a broadcast program of map update data;

FIG. 6 is a flowchart of a process in a cellular phone several minutes prior to a reservation time;

FIG. 7 is a flowchart of a reception reservation process for a broadcast program of map update data;

FIG. 8 is a flowchart of a interruption supplement process for data reception in the cellular phone; and

FIG. 9 is a flowchart of a map update process in the cellular phone and the car navigation apparatus.

### DETAILED DESCRIPTION OF THE PREFERRED EMBODIMENTS

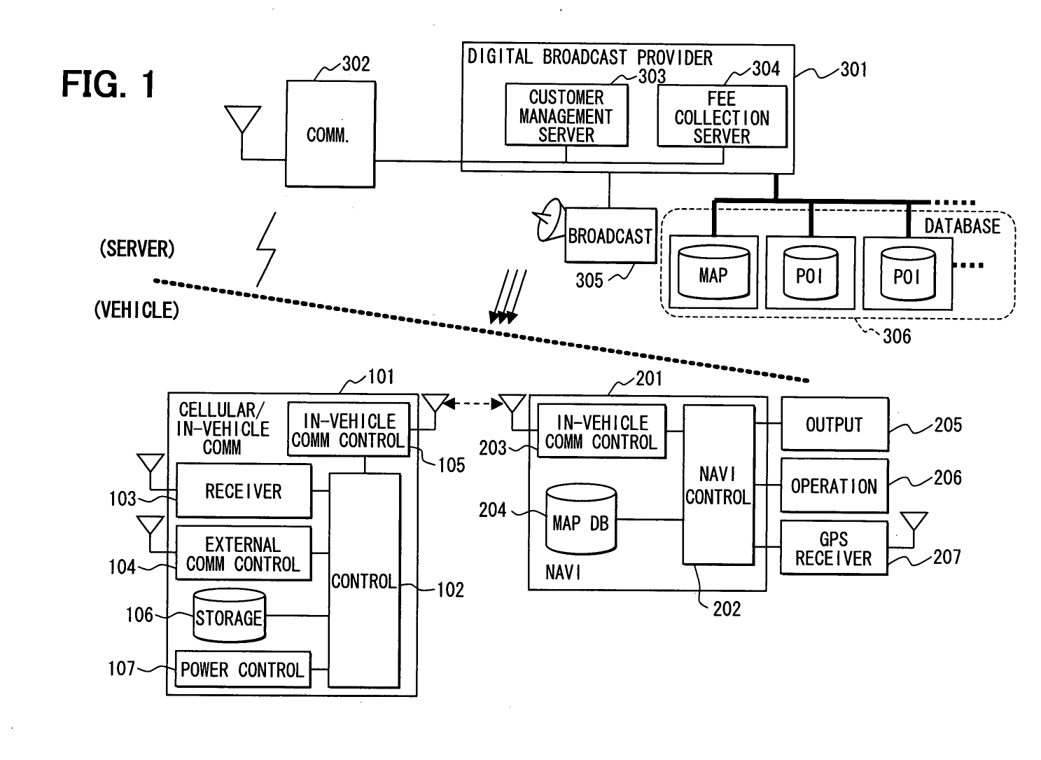

A map data update system according to an embodiment of the present invention is explained with reference to the drawings. The configuration of the map data update system is illustrated in FIG. 1. The map data update system includes a cellular phone (or in-vehicle communication apparatus) 101 which receives map update data broadcasted over data broadcast waves, a car navigation apparatus 201 mounted in a subject vehicle, and a digital broadcast provider (as a map update data broadcast installation) 301 having a broadcast apparatus 305 which broadcasts map update data.

The digital broadcast provider 301 includes a communication means 302 which executes communication with the cellular phone 101, a customer management server 303, a fee collection server 304, and a broadcast apparatus 305. In addition, the digital broadcast provider 301 is connected with a database group 306 which includes a map database of a map information provider and a POI (Point Of Interest) database of a contents provider (CP).

The communication means 302 includes not only a communicator compliant with ETC (Electronic Toll Collection System), DSRC (Dedicated Short Range Communication), wireless LAN (Local Area Network) etc., but also an external communicator which can communicate wirelessly with the cellular phone 101 via the cellular phone network. The customer management server 303 is to manage a variety of information of customers who receive data of the database group 306. The fee collection server 304 is to store charging information for every customer. The broadcast apparatus 305 broadcasts the various data of map update data etc. over data broadcast waves.

The cellular phone 101 includes a control section 102, a digital broadcast receiver 103, an external wireless communication control section 104, an in-vehicle wireless communication control section 105, a storage section 106, and a power control section 107. The cellular phone 101 is operable by receiving a power supply from a battery (not shown). The control section 102 mainly includes a microcomputer having a CPU (Central Processing Unit), a ROM (Read-Only Memory), a RAM (Random Access Memory), an I/O (input/Output), and a bus that connects the foregoing. The CPU executes predetermined data processing according to a program written in the ROM.

The digital broadcast receiver 103 is to receive various data of the map update data etc. which are broadcasted by the digital broadcast provider 301. The external wireless communication control section 104 communicates with the communication means 302 of the digital broadcast provider 301 via the cellular phone network. The in-vehicle wireless communication control section 105 is connected with the in-vehicle wireless communication control section 203 of the navigation apparatus 201 via the short range wireless communication or communication link such as Bluetooth and wireless LAN.

The storage section 106 is to store the various data of the map update data etc. received by the digital broadcast receiver 103. The storage section 106 uses a nonvolatile storage medium. The power control section 107 executes ON-OFF control of the power supply of the cellular phone 101, and also monitors a residual quantity of the battery (or residual battery quantity).

The navigation apparatus 201 includes a navigation control section 202, an in-vehicle wireless communication control section 203, a map database 204, an image and audio output section 205 including a display device and an audio output device, an operation section 206, and a GPS (Global Positioning System) receiver 207. The navigation control section 202 mainly includes a microcomputer having a CPU, ROM, RAM, I/O, and bus connected with the foregoing. The CPU executes predetermined data processing according to a program written in the ROM.

The in-vehicle wireless communication control section 203 communicates via the short range wireless communication, such as Bluetooth and wireless LAN with the in-vehicle wireless communication control section 105 of the cellular phone 101. Thus, the fast transfer of the data via the short range wireless communication is possible for the cellular phone 101 and the navigation apparatus 201.

The map database 204 is a storage device to store map data containing road data, background data, and character data. The map database 204 uses a storage medium such as a DVD (Digital Versatile Disk), a hard disk drive, etc. based on the required data volume. The map data can be updated by acquiring the map update data (for instance, only data for a difference part) broadcasted by the digital broadcast provider 301.

The image and audio output section 205 includes a liquid crystal display as the display device, an amplifier, and a speaker. The screen of the display device displays a mark corresponding to a present position and indicating a heading direction and a road map around the present position generated with the map data inputted from the map database 204. Furthermore, when a destination is designated, a guidance route from the present position to the destination can be displayed in superimposition on the road map. Display information in the display device is controlled by the navigation control section 202.

The operation section 206 includes a mechanical switch or a touch switch integrated with the display device, and is used for various inputs. The navigation apparatus 201 has a so-called route guidance function to automatically retrieve an optimal route from a present position to a destination to thereby display the guidance route. In such a function, the destination can be inputted via the operation section 206.

The technique of automatically designating the guidance route uses, for instance, the known Dijkstra method. Moreover, the navigation apparatus 201 has a search function to retrieve a facility or the like using the map data. In such a function, the operation section 206 is used for inputting addresses, facility names, telephone numbers, etc.

The GPS receiver 207 measures a present position and heading direction based on radio waves from GPS satellites.

The above map data update system is devised by taking into consideration that the update of the map data in a navigation apparatus is generally only when or while a user is located within the vehicle. That is, in order to usually operate a navigation apparatus fixedly mounted in a vehicle, it is indispensable for a user to operate the key position of the vehicle to the accessory position, or to operate the engine into the drive state. Such an operation is only carried out when a user uses the vehicle for driving. Therefore, the user can generally execute the update of the map data of the navigation apparatus only while the user is located in the vehicle.

To that end, the map data update system according to the present embodiment is designed as follows. The cellular phone 101, which is always data receivable in regard to a time zone and a communication area, is further designed as including a large data-volume storage device capable of receiving data broadcast waves. Regardless of the state of the use of the vehicle by a user, the cellular phone 101 receives map update data distributed or transmitted as data broadcast waves before the navigation apparatus 201 starts (or before the start-up of the navigation apparatus 201).

Thus, the map update data is previously stored in the cellular phone 101 the user carries when the user gets in the vehicle. At the time of or in response to the start-up of the navigation apparatus 201, the map update data can be fast transferred to the navigation apparatus 201 from the cellular phone 101 via the short range wireless communication between the in-vehicle wireless communication control sections 105 and 203. As a result, such a configuration need not choose a place for receiving map data having a large data volume and helps avoid giving stress to a user at the time of the update of the map data.

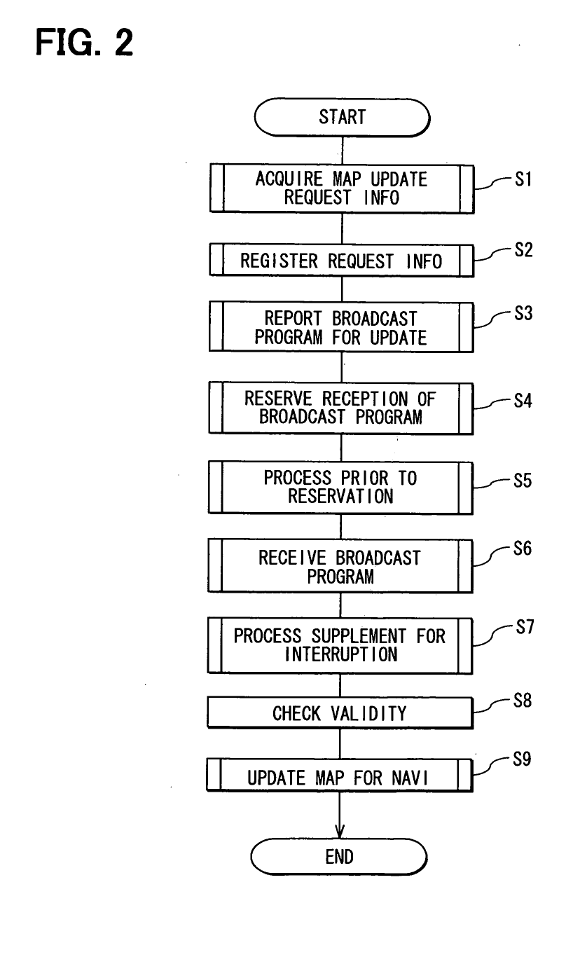

The following explains a map update data distribution process for the navigation apparatus 201 in the map data update system. FIG. 2 is a flowchart for the map data update system to illustrate an order of operations. At S1, an acquisition process for map update request information is executed between the cellular phone 101 and the navigation apparatus 201. At S2, a registration process for the map update request information is executed between the cellular phone 101 and the digital broadcast provider 301.

At S3, a report process for a broadcast program (EPG) for the map update data is executed between the cellular phone 101 and the digital broadcast provider 301. At S4, a reception reservation process of the broadcast program of the map update data is executed in the cellular phone 101. At S5, a process several minutes prior to the reservation time is executed in the cellular phone 101.

At S6, a reception process for the broadcast program of the map update data is executed in the cellular phone 101. At S7, an interruption supplement process for the data reception is executed in the cellular phone 101. At S8, a validity check process for the reception data is executed in the cellular phone 101. Finally, at S9, a map update process is executed between the cellular phone 101 and the navigation apparatus 201.

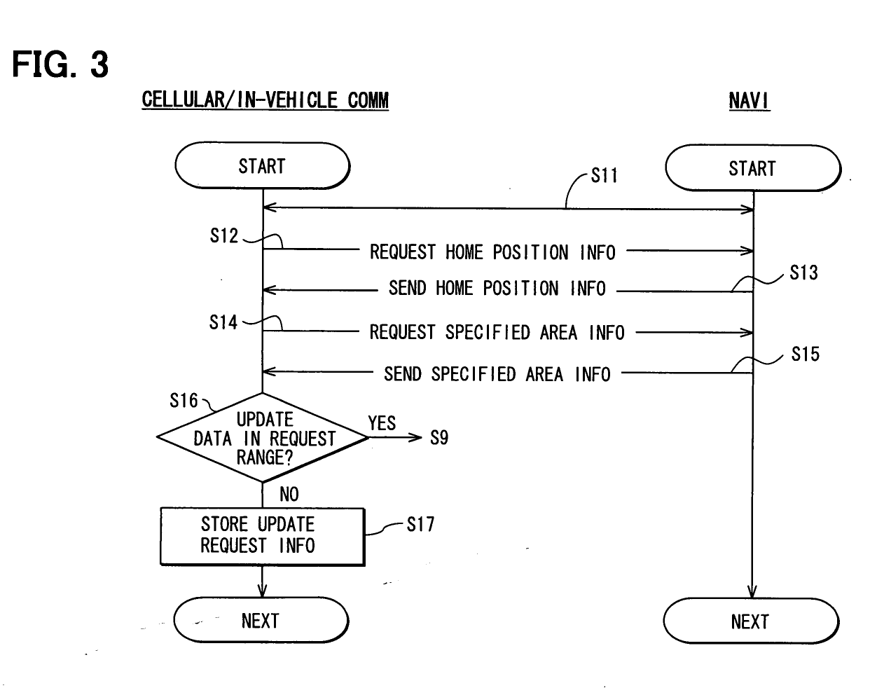

Next, the processing of S1 to S7, and S9 are individually explained with reference to FIGS. 3 to 9. The acquisition process of the map update request information at S1 is illustrated in FIG. 3. First, when a map update application for map update is started in the cellular phone 101, the cellular phone 101 is authenticated by the navigation apparatus 201 at S11.

In the authentication, a user ID and its corresponding password are entered from the cellular phone 101 and transmitted to the navigation apparatus 201. In the navigation apparatus 201, it is determined whether the received user ID and password accord with those previously registered. When it is successfully determined, it is determined that the cellular phone 101 is previously registered; then the communication can be continued between the navigation apparatus 201 and the cellular phone 101.

When the user does not previously specify a position as a target of the map update, the cellular phone 101 transmits a Request to Send of home position area information on home such as position information, area ID, and version, to the navigation apparatus 201 at S12. At S13, the navigation apparatus 201 transmits the home position area information to the cellular phone 101 in response to the Request to Send of the home position area information. The position information is a set of coordinates (longitude and latitude) of the home; the area ID is an identification number of the applicable area (for example, prefectures, cities, wards, towns, and villages, etc.) of the home; the version is information on version of the map data of the applicable area.

In contrast, when the user specifies previously the position as a target of the map update, a Request to Send of the specified area information is transmitted from the cellular phone 101 to the navigation apparatus 201 at S14. At S15, the navigation apparatus 201 transmits the specified area information to the cellular phone 101 in response to the relevant Request to Send. The position information in the specified area information is a set of coordinates of the position (for example, destination point etc.) which the user specifies; the area ID is an identification number of the specified applicable area of the position; in addition, the version is information on the version of the map data of the applicable area.

At S16, with reference to the home position area information or the specified area information, it is determined whether the map update data of the applicable area (update request range) is stored in the storage section 106 of the cellular phone 101. When the affirmative determination is made at S16, the processing proceeds to the map update process at S9. When the negative determination is made at S16, the processing proceeds to S17. At S17, the map update request information is prepared and stored based on the home position area information or the specified area information.

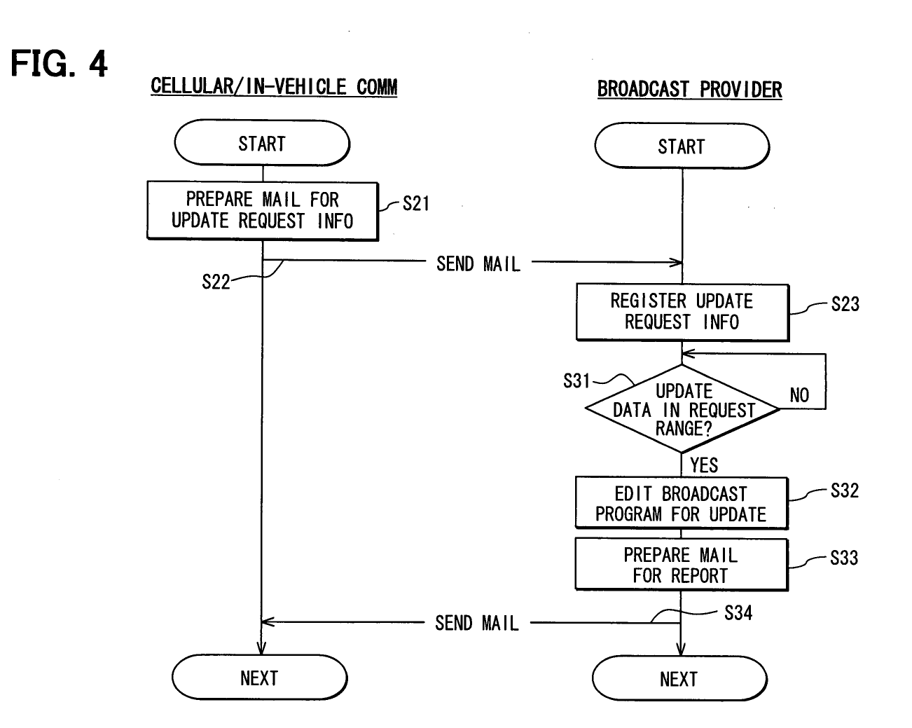

The following explains S2 or S21 to S23 for the registration process for the map update request information and S3 or S31 to S34 for the report process for the broadcast program (EPG) of the map update data with reference to FIG. 4. First, at S21, a transmitting mail of the map update request information is prepared or generated by the map update application in the cellular phone 101. At S22, the transmitting mail of the map update request information is transmitted from the cellular phone 101 to the digital broadcast provider 301. At S23, the digital broadcast provider 301 registers the received map update request information.

At S31, it is determined in the digital broadcast provider 301 whether the database group 306 has an update of the map data of the update request range. When the affirmative determination is made at S31, the processing proceeds to S32. When the negative determination is made at S31, a response mail is transmitted to the cellular phone 101. The response mail indicates that since there is no update of the map data of the update request range, EPG data is transmitted as soon as it is updated. Thus, the standby state is held until the map data of the update request range is updated.

When the map data of the update request range is updated at S32, a broadcast program is edited for broadcasting map data for the update request range. The edited broadcast program includes a channel for broadcasting the map update data, and a broadcast clock time (reservation setting data based on EPG, EPG data), data size, and a version of the map update data. At S33, the report mail of the broadcast program edited at S32 is prepared or generated. The EPG data are attached to the report mail. At S34, the report mail generated in the digital broadcast provider 301 at S33 is transmitted to the cellular phone 101. Then, as mentioned later, in the digital broadcast provider 301, the map update data according to the contents of the map update request information is broadcasted. The above configuration can provide the user of the navigation apparatus 201 with the distribution of the map update data, as needed, using the on-demand broadcast reception via the cellular phone 101.

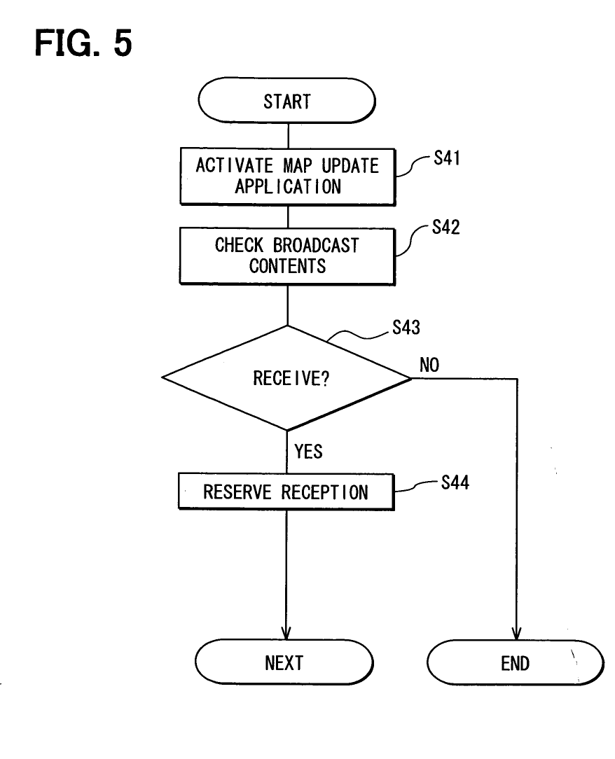

FIG. 5 illustrates the reception reservation process for the broadcast program of the map update data executed in the cellular phone 101. At S41, the map update application is started. At S42, the contents of the broadcast program of the map update data are confirmed. At S43, the user is requested or prompted to determine whether to receive the map update data having such contents of the broadcast program. When an instruction for the reception from the user is inputted via the cellular phone 101, the reception reservation to receive the map update data is made for the contents of the broadcast program at S44. Thereby, in the cellular phone 101, the reception of the map update data can be started at the broadcast time when the reception is reserved. In addition, the present process is ended when an instruction not to receive is made from the user via the cellular phone 101.

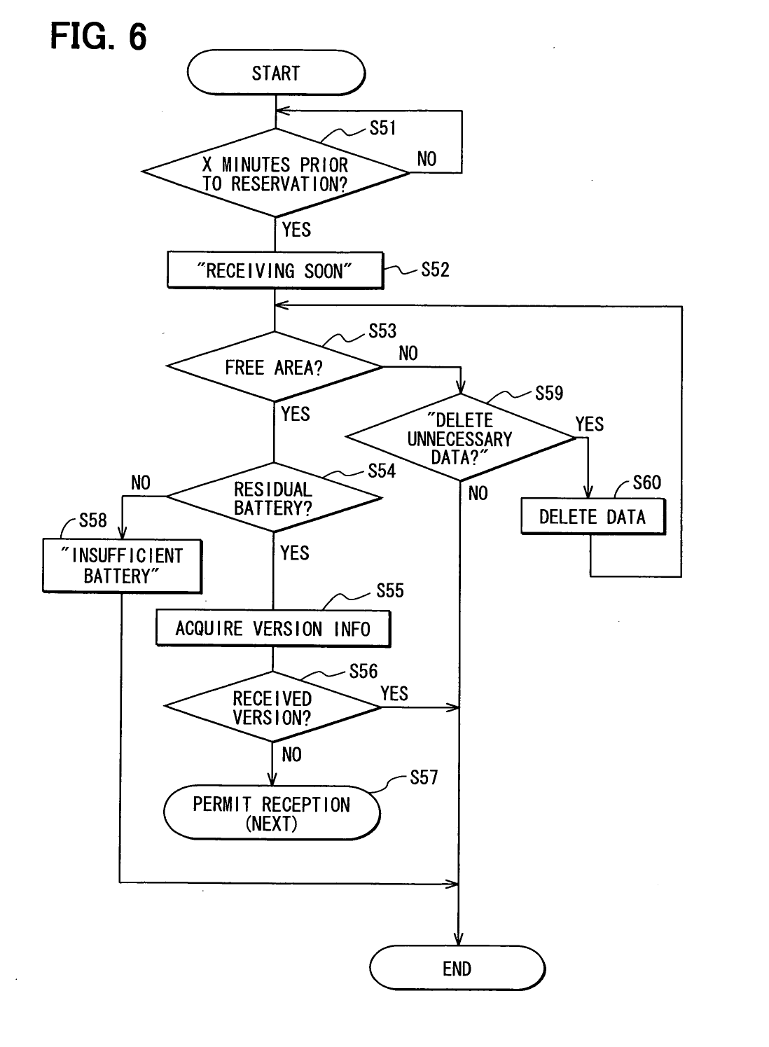

FIG. 6 illustrates the process several minutes prior to the reservation time executed in the cellular phone 101. At S51, the broadcast schedule time is referred to from the report mail of the broadcast program of the map update data, and it is determined whether it comes X minutes e s prior to the reservation time (for example, 5 minutes before). When the affirmative determination is made at S51, the processing advances to S52; when the negative determination is made, the standby state is maintained until it comes X minutes prior to the reservation time.

At S52, a message for indicating “receiving map update data soon” is reported to the user by using an alarm function of the cellular phone 101, etc. via the image display or audio output; the user is thereby notified of the automatic reception of the map update data being started.

At S53, the data size is referred to from the report mail of the broadcast program of the map update data, and it is determined whether a free storage area to accommodate the map update data is present in the storage section 106 of the cellular phone 101. When the affirmative determination is made at S53, the processing proceeds to S54. When the negative determination is made at S53, the processing proceeds to S59.

At S54, the residual battery quantity of the cellular phone 101 is referred to, and it is determined whether the present residual battery quantity can allow the reception of the map update data. When the affirmative determination is made at S54, the processing proceeds to S55. When the negative determination is made at S54, a message for indicating “insufficient battery residual” is outputted in a display image or audio output at S58 to thereby notify the user of the residual battery quantity being insufficient.

At S55, the version of the map update data is acquired from the report mail of the broadcast program of the map update data. At S56, it is determined whether the version included in the report mail is a version previously acquired. When the affirmative determination is made at S56, the present process is ended. When the negative determination is made at S57, the processing advances to S57. At S57, the reception of the map update data is permitted.

At S59, a message for indicating “whether to delete unnecessary data” is outputted as a display image or audio output to thereby notify the user of whether to delete the data which the storage section 106 stores. Thereafter, when an instruction to delete it from the user is inputted via the cellular phone 101, the data unnecessary is deleted at S60. In contrast, when an instruction not to delete is inputted via the cellular phone 101, the present process is ended.

As explained above, the process several minutes prior to the reservation time in FIG. 6 performs as follows. At a time point X minutes prior to the broadcast schedule clock time for the map update data, the reference is made with respect to the free storage area of the storage section 106, the residual battery quantity of the cellular phone 101, and the version of the map update data. Thereby, it is determined whether the reception of the map update data can be permitted. Such a configuration enables the determination as to whether the cellular phone 101 is ready for receiving the map update data such as whether the cellular phone 101 secures a free storage area for storing the map update data, whether the residual battery quantity is sufficient for receiving the map update data, or whether the version of the map update data to be received is correct.

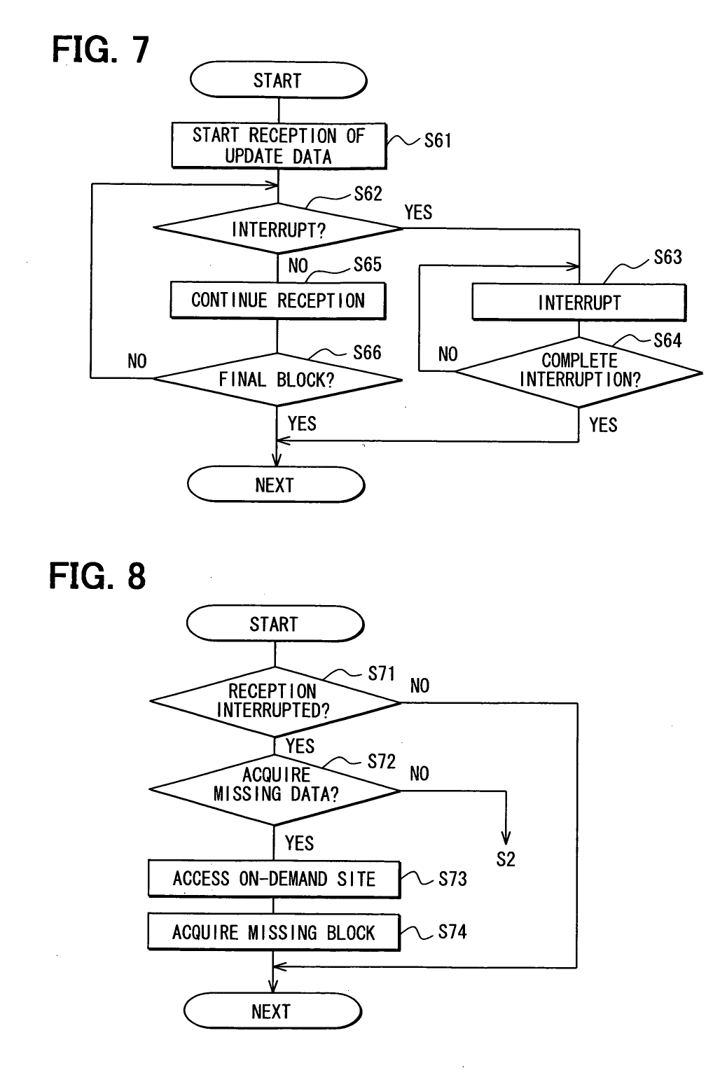

FIG. 7 illustrates the reception process for the map update data broadcast program. At S61, the reception of the map update data is started. At S62, the presence or absence of the interruption factors assumed to take place under the reception of the map update data is determined. The interruption factors include, for example, a reception interruption operation by the user to prepare a mail, or an incoming call of the cellular phone 101.

When the affirmative determination is made at S62 (i.e., the presence of the interruption factor is determined), the processing proceeds to S63. When the negative determination is made at S62, (the absence of the interruption factor is determined), the processing advances to S65. At S63, the interruption process is performed to interrupt the reception of the map update data. At S64, it is determined whether the above interruption factor is completed or eliminated.

When the affirmative determination is made at S64, the processing proceeds to S7. When the negative determination is made at S64, the processing at S63 is repeatedly performed. Thus, when an interruption factor is present or the interruption factor occurs, the reception of the map update data is interrupted. This can prevent an execution of other functions of the cellular phone 101 from being barred.

At S65, the reception of the map update data is continued. At S66, it is determined whether the final data block of the map update data is completely received. When the affirmative determination is made at S66, the processing proceeds to S7. When the negative determination is made at S66, the processing advances to S62 and the processing mentioned above is repeatedly performed.

FIG. 8 illustrates an interruption supplement process for the data reception executed in the cellular phone 101. At S71 in FIG. 8, it is determined whether there is any interruption or discontinuation in the data reception of the map update data. When the affirmative determination is made at S71, the processing advances to S72; when the negative determination is made at S71, the processing advances to S8.

At S72, the user is notified of whether to acquire, from now on, the data block missing by the interruption. When an instruction for acquiring the missing data block is inputted by the user, the processing advances to S73. When an instruction for not acquiring the missing data block is inputted by the user, the processing advances to S2.

Thus, the user is prompted to input an instruction of whether to resume the reception of the map update data after the reception of the map update data is interrupted. Thus the user can input an instruction to resume the reception of the map update data as needed.

At S73, the on-demand site of the map update data is accessed. At S74, the missing data block is acquired. Thus, when the reception of the map update data is interrupted for a certain dominant cause, the reception of the map update data broadcast is succeedingly resumed from the time point at which the interruption factor disappears. However, because of the nature of the broadcast data, there is no measure to receive the data tracing back to immediately after the interruption; thus, after receiving the final data block of the planned reception data, the user is prompted to select the supplement process for receiving the missing data.

The reason why the user is prompted to select or determine the reception of the missing data is as follows. The fee collection method for the data communication changes based on the contract terms for each user. Further, the urgency of the data reception differs each time. Thereby, the execution or selection of receiving the missing data cannot be simply determined without confirming the user intention or desire.

At S8 in FIG. 2, after acquiring all the scheduled reception data, the validity of the received data is checked. For example, in order to evaluate the validity of the reception data, a data error detection or an error correction process such as a CRC error check may be adopted.

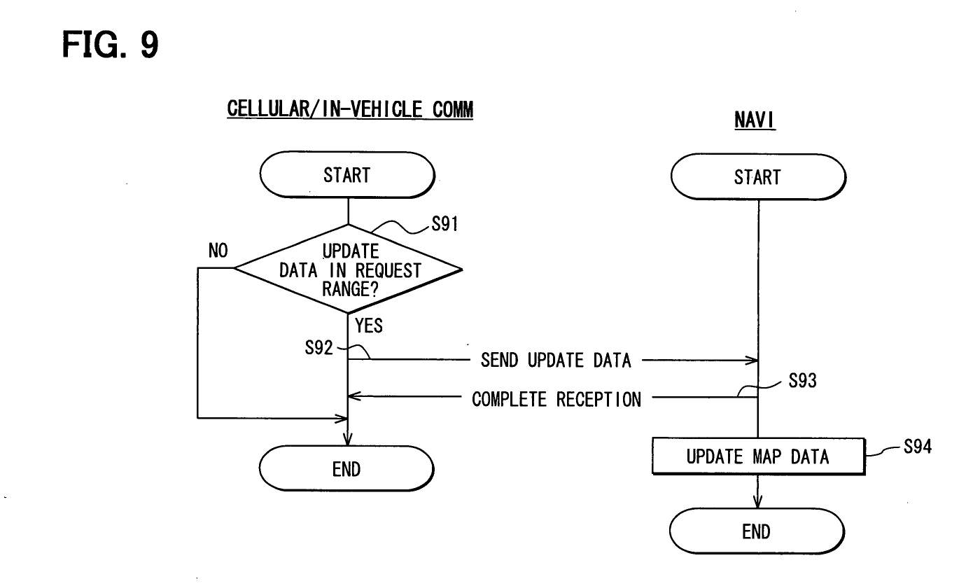

FIG. 9 illustrates the map update process executed between the cellular phone 101 and the navigation apparatus 201. When the user, who possesses the cellular phone 101, gets in the vehicle and the navigation apparatus 201 starts after that, it is determined in the cellular phone 101 at S91 in FIG. 9 whether the map update data of the update request range is stored in the storage section 106. When the affirmative determination is made at S91, the processing advances to S92; when the negative determination is made at S91, the present process is ended.

At S92, the map update data is transmitted to the navigation apparatus 201 from the cellular phone 101 via the short range wireless communication. When the reception of the map update data is completed in the navigation apparatus 201, the information for indicating the completion of the data reception is transmitted to the cellular phone 101. In the navigation apparatus 201, the map data is updated by using the received map update data at S94. Thereby, the map data of the navigation apparatus 201 serves as the newest version, and is thereafter reflected on the route guidance etc. executed by the navigation apparatus 201.

Thus, in the map data update system of the present embodiment, before the navigation apparatus 201 starts, the cellular phone 101 receives the map update data from the digital broadcast provider 301. The received map update data is stored in the storage section 106, and the map update data stored in the storage section 106 is then transmitted to the navigation apparatus 201 at the time of the start-up of the navigation apparatus 201. Upon receiving the map update data, the car navigation apparatus 201 updates the map data by using the received map data update data.

Under such a configuration, when the user gets in the vehicle, the map update data is stored in the cellular phone 101 carried by the user. At the time of or in response to the start-up of the navigation apparatus 201, the map update data can be fast transferred to the navigation apparatus 201 from the cellular phone 101 via the short range wireless communication. As a result, such a configuration need not choose a place for receiving the map data having a large data volume and helps avoid giving stress to the user at the time of the update of the map data.

Each or any combination of processes, steps, or means explained in the above can be achieved as a software portion or unit (e.g., subroutine) and/or a hardware portion or unit (e.g., circuit or integrated circuit), including or not including a function of a related device; furthermore, the hardware portion or unit can be constructed inside of a microcomputer.

Furthermore, the software portion or unit or any combinations of multiple software portions or units can be included in a software program, which can be contained in a computer-readable storage media or can be downloaded and installed in a computer via a communications network.

The preferred embodiment of the present invention is thus described; however, without being restricted to the embodiment mentioned above, the present invention can be variously modified as long as not deviating from the scope thereof.

What is claimed is:

1. A map data update system comprising:
a map update data broadcast installation having a broadcast apparatus for broadcasting map update data over data broadcast waves;
a mobile communication apparatus including
(i) a data broadcast receiver for receiving the map update data broadcast from the map update data broadcast installation,
(ii) a storage device for storing the map update data received by the data broadcast receiver, and
(iii) a short-distance transmitter for transmitting the map update data stored in the storage device via short distance communication; and
a vehicular navigation apparatus including map data and having a short-distance receiver for receiving the map update data transmitted by the mobile communication apparatus,
wherein:
the mobile communication apparatus receives the map update data before a start-up of the navigation apparatus, stores the received map update data in the storage device, and transmits to the navigation apparatus the map update data stored in the storage device in response to the start-up of the navigation apparatus; and
upon receiving the map update data, the navigation apparatus updates the map data.

2. The map data update system according to claim 1, wherein:
the mobile communication apparatus transmits map update request information to the map data broadcast installation using an external communication device which executes communication with the map update data broadcast installation; and
upon receiving the map update request information the map update data broadcast installation broadcasts map update data corresponding to a data content of the received map update request information.

3. The map data update system according to claim 2, wherein:
upon receiving the map update request information, the map data broadcast installation transmits map update data broadcast information containing a broadcast time of the map update data to the mobile communication apparatus; and
the mobile communication apparatus further includes a reception reservation means to perform a reception reservation for the data broadcast receiver to receive map update data at the broadcast time of the map update data contained in the map update data broadcast information.

4. The map data update system according to claim 3, wherein:
the map update data broadcast information from the map data broadcast installation includes version information of the map update data; and
the mobile communication apparatus further includes a reception permission determination means to determine, before the broadcast time of the map update data, whether reception of the map update data is permitted based on at least one of a free storage area of the storage device, a battery residual quantity, and the version of the map update data.

5. The map data update system according to claim 1, wherein:
the mobile communication apparatus further includes a reception interruption determination means to determine presence or absence of an interruption factor under reception of the map update data; and
the data broadcast receiver interrupts the reception of the map update data when the presence of the interruption factor is determined.

6. The map data update system according to claim 5, wherein
the mobile communication apparatus further includes an instruction input means for causing a user to input an instruction of whether to resume the reception of the map update data after the interruption of the reception of the map update data is completed.
